(19) United States
(12) Patent Application Publication
(10) Pub. No.: US 2023/0202311 A1
(43) Pub. Date: Jun. 29, 2023

(54) Integrated Storage and Generation

(71) Applicant: Alexander Charles Kurple, Casco, MI (US)

(72) Inventor: Alexander Charles Kurple, Casco, MI (US)

(21) Appl. No.: 17/564,230

(22) Filed: Dec. 29, 2021

(51) Int. Cl. B60L 50/50

(52) U.S. Cl. CPC B60L 50/50

(57) ABSTRACT

The invention gives the user the user the ability to power a machine with another power source with a greater capacity, lower cost, multiple power, higher quality, or better equipped for the situation of operating the machine.

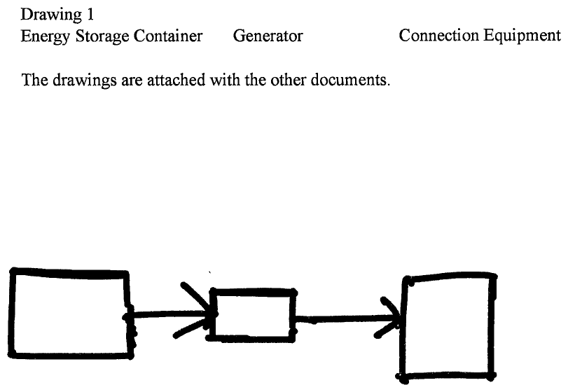

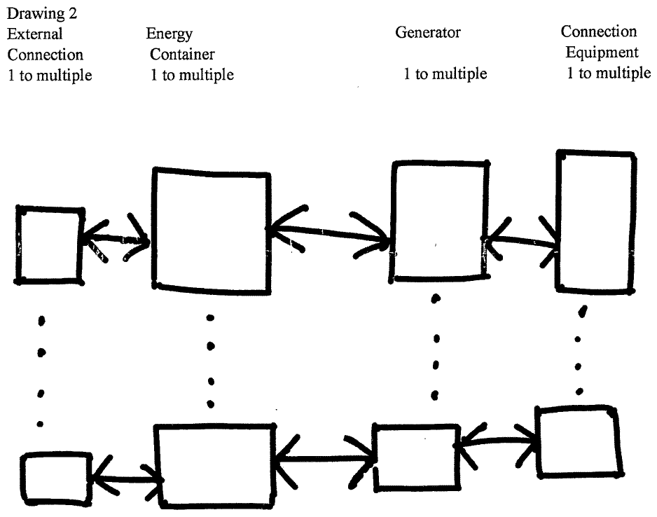

### CROSS-REFERENCE TO RELATED APPLICATIONS

Not Applicable

### STATEMENT REGARDING FEDERALLY SPONSORED RESEARCH

Not Applicable

### REFERENCE TO A SEQUENCE LISTING

Not Applicable

### BACKGROUND OF THE INVENTION

The invention gives a person the option to have portable generation with integrated storage. In many applications the storage of energy does not have enough capacity to support the needs of the consumer. In an electric vehicle the batteries might not have enough capacity to drive the necessary distance. The invention includes the integration of a energy storage of higher density a generator and battery or capacitor circuits to give an equivalent connection to the vehicle so the same structure of the vehicle can be used without having to change the architecture. The invention includes multiple storage and generation options to combine the benefits of portability with the increase in storage.

### BRIEF SUMMARY OF THE INVENTION

The invention consists of an integrated energy storage container, a generator or other machine to convert the energy to power, the circuitry or other components to connect the power to the other machine. The invention can include multiple energy storage and multiple power outputs to the machine. The energy storage can attach to a larger storage or continuous supply to maintain continuous operation. The invention also contains the option to operate in reverse to produce energy from excess power in the connected machine to continue the operation.

### BRIEF DESCRIPTION OF THE SEVERAL VIEWS OF THE DRAWING

The Drawing 1 shows the main components the energy storage container, the generator or converter, the connection equipment to the machine.

The Drawing 2 shows the invention with the options to have multiple energy storage containers, an optional connection to external storage, generator or converter, and the connection equipment to the machine.

The invention could have one, none, or multiples of the components.

### DETAILED DESCRIPTION OF THE INVENTION

The invention provides power to a second machine by connected to it or replacing the storage in the machine with a an energy storage container, generator or converter, and the the connection equipment to the machine. The invention gives the operator the ability to substitute a higher density energy or lower cost storage to maintain or increase the operation of the machine. The energy container can include batteries, liquid tanks, gas tanks, pressure cylinders, gas absorbing metals or plastics, hydraulic cylinders, ice, metal containers, pressure vessels, chemical bonds, or any other material to store energy in the machine. The drawing 1 shows the energy is converted to power and connected to the machine. In the example of the electric vehicle. One option the batteries are taking out of the vehicle and substituted with the invention. The operator would fill the energy storage with gasoline or fuel and the generator or converter would send the electrical power to the vehicle through the connection equipment. The connection equipment would have the necessary circuits and batteries or capacitors to connect an equivalent circuit to the vehicle. Instead of having to wait to charge the vehicle the operator could fill the storage with fuel and continue the operation. The invention would let the user replace worn out batteries at a lower cost. The other outputs of the generator including the heat could be sent into the vehicle to increase the temperature inside. The generator or converter can be any machine to take the energy and change it to power of the type necessary to operate the vehicle. The generator or converter could include alternators, thermoelectric generators, solar panels, nuclear reactor, turbines, diodes, compressed air motor, electric inverter, hydraulic motor, fuel cell, internal combustion engine, steam engine, or any other type of generator or converter to take energy and change it to power for the operator. In portable electronics the invention could consist of hydrogen storage, a fuel cell, and the connection circuit to connect to the machine. The battery would be replace with the invention and the operator would have another option to power the machine. The fuel cell would change the hydrogen and oxygen in the air to water and produce electrical energy that would be sent to the machine and the water exhausted or contained to empty with the new fuel in the storage container. The generator could include circuitry to charge the storage by breaking down the water into hydrogen and storing it or compressing it first to let the user charge it by moving the storage near an external power connection. The

1. A machine consisting of an energy storage container, a generator or converter, connection to equipment to power a machine or multiple machines.

2. A machine consisting of multiple energy storage containers, a generator or converter, connection to equipment to power a machine or multiple machines.

3. A machine consisting of multiple energy storage container, multiple generators or converters, connection to equipment to power a machine or multiple machines.

4. A machine consisting of multiple energy storage container, multiple generators or converters, and multiple connection equipment to power a machine or multiple machines. A machine consisting of a connection or multiple connections to an external energy storage and with or without internal energy storage containers, one or multiple generators or converters, and one or multiple connection equipment to power a machine or multiple machines.
